(19) United States
(12) Patent Application Publication
(10) Pub. No.: US 2010/0304936 A1
(43) Pub. Date: Dec. 2, 2010

(54) CONVEYOR BELT OR TREADMILL BELT

(76) Inventor: Shuei Mu Wang, Taichung City (TW)

Correspondence Address: Dr. BANGER SHIA;Patent Office of Bang Shia, 102 Lindencrest Ct, Sugar Land, TX, 77479-5201, US

(21) Appl. No.: 12/474,182

(22) Filed: May 28, 2009

(51) Int. Cl. A63B 22/02; B32B 27/12; B32B 27/14

(52) U.S. Cl. 482/54; 442/286; 428/196; 442/294

(57) ABSTRACT

A conveyor belt or treadmill belt comprises a cloth layer woven by at least one warp and woof and having an outer surface and an inner surface in response to each other, a clearance passing through the inner and the outer surfaces and being formed between the warp and the woof; a laminating layer serving as being stepped, the laminating layer being molded to a laminated film and melted to couple with an outer surface of the cloth layer, such that the laminating layer merges into the clearance between the warp and the woof of the cloth layer so that the laminating layer is integrally formed a rough connecting surface; a gel layer coated on an inner surface of the cloth layer so as to link with the connecting surface of the laminating layer, thus engaging the cloth layer between the gel layer and the laminating layer.

### BACKGROUND OF THE INVENTION

1. Field of the Invention

The present invention relates to a conveyor belt or treadmill belt that can dispose a shock absorbing structure in the laminating layer to obtain a preferred stepping comfortness.

2. Description of the Prior Art

Referring to FIG. 1, a conventional conveyor belt or treadmill belt are coupled together in high frequency manner so that the conveyor belt or treadmill belt can be fixed on front and rear transmission wheels (not shown) respectively, obtaining conveying or stepping function.

As shown in FIGS. 2-4, the conventional conveyor belt or treadmill belt at least comprises:

a cloth layer 1 woven by at least one warp 11 and woof 12, a clearance 13 being formed between the warp 11 and woof 12, an inner surface of the cloth layer 1 being fixed around outer sides of two transmission wheels;

an adhesive layer 2 serving as coating adhesive agent onto an outer side of the cloth layer 1 by using a gel coating machine so that the gel can merge into the clearance 13 of the cloth layer 1 and then the cloth layer 1 being dried by a dryer;

a leather layer 3 adhered on the outer surface of the cloth layer 1 by using the adhesive layer 2.

However, such a conventional conveyor belt or treadmill belt is easy to be peeled off and has poor stepping stress.

The present invention has arisen to mitigate and/or obviate the afore-described disadvantages.

### SUMMARY OF THE INVENTION

The primary object of the present invention is to provide a conveyor belt or treadmill belt that can dispose a shock absorbing structure in the laminating layer to obtain a preferred stepping comfortness.

A conveyor belt or treadmill belt in accordance with the present invention comprises:

a cloth layer woven by at least one warp and woof and having an outer surface and an inner surface in response to each other, a clearance passing through the inner and the outer surfaces and being formed between the warp and the woof of the cloth layer;

a laminating layer serving as being stepped, the laminating layer being molded to a laminated film and melted to couple with the outer surface of the cloth layer, such that the laminating layer merges into the clearance between the warp and the woof of the cloth layer so that the laminating layer is integrally formed a rough connecting surface;

a gel layer coated on the inner surface of the cloth layer so as to link with the connecting surface of the laminating layer, thus engaging the cloth layer between the gel layer and the laminating layer.

### BRIEF DESCRIPTION OF THE DRAWINGS

FIG. 1 is a perspective view of a conventional treadmill;

FIG. 2 is a plan view of a cloth layer of a conventional conveyor belt or treadmill belt;

FIG. 3 is a horizontal cross sectional view of the cloth layer of the conventional conveyor belt or treadmill belt;

FIG. 4 is a longitudinal cross sectional view of the cloth layer of the conventional conveyor belt or treadmill belt;

FIG. 5 is a horizontal cross sectional view of a conveyor belt or treadmill belt in accordance with a first embodiment of the present invention;

FIG. 6 is a longitudinal cross sectional view of the conveyor belt or treadmill belt in accordance with the first embodiment of the present invention;

FIG. 7 is a horizontal cross sectional view of a conveyor belt or treadmill belt in accordance with a second embodiment of the present invention;

FIG. 8 is a cross sectional view showing a laminating layer being provided with a shock absorbing structure;

FIG. 9 is a top plan view of the shock absorbing structure of the conveyor belt or treadmill belt in accordance with the second embodiment of the present invention;

FIG. 10 is a cross sectional view of the shock absorbing structure of the conveyor belt or treadmill belt in accordance with the second embodiment of the present invention;

FIG. 11 is a cross sectional view of the shock absorbing structure of the conveyor belt or treadmill belt in accordance with a third embodiment of the present invention.

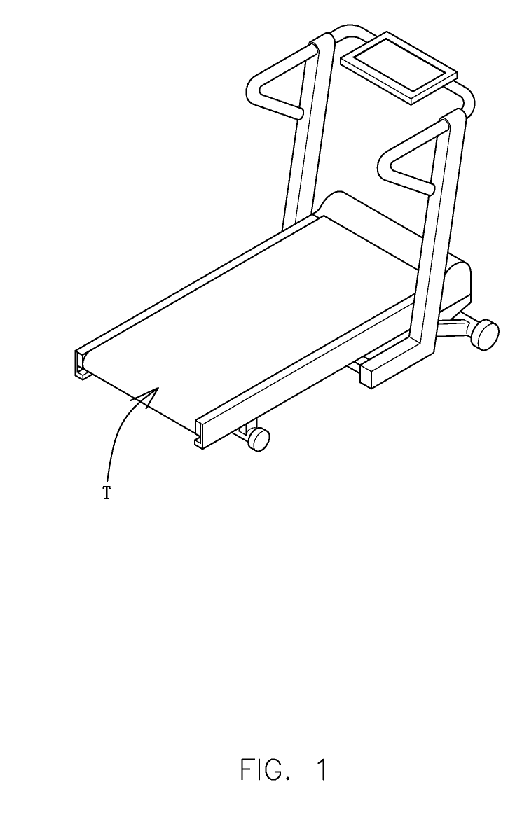

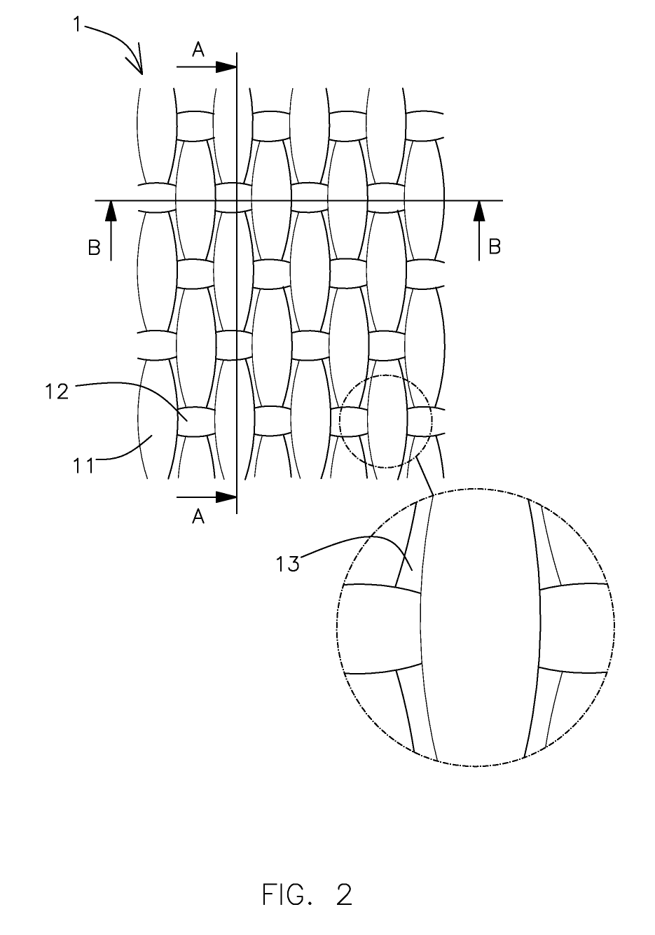

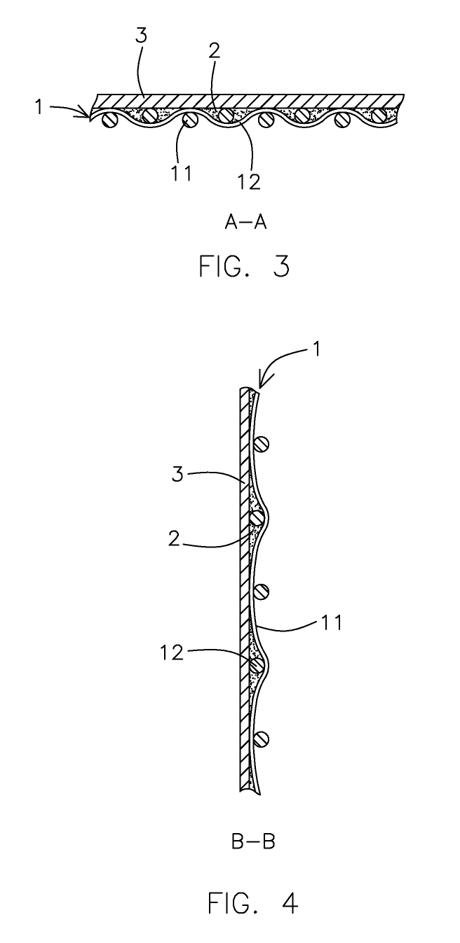

### DETAILED DESCRIPTION OF THE PREFERRED EMBODIMENTS

The present invention will be clearer from the following description when viewed together with the accompanying drawings, which show, for purpose of illustrations only, the preferred embodiment in accordance with the present invention.

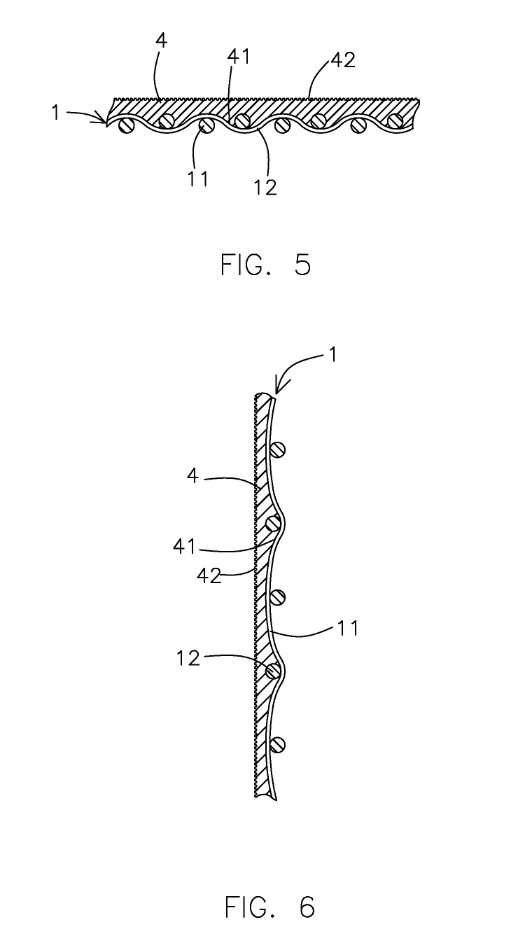

Referring to FIGS. 5 and 6, a conveyor belt or treadmill belt in accordance with a first embodiment of the present invention at least comprises: a cloth layer 1 woven by at least one warp 11 and woof 12 and having an outer surface and an inner surface in response to each other, a clearance passing through the inner and the outer surfaces and being formed between the warp 11 and the woof 12 of the cloth layer 1, wherein the warp 11 and the woof 12 can be formed from yarns with anti-static agent or the cloth layer 1 is soaked in the anti-static agent to obtain anti-static effect;

a laminating layer 4 serving as being stepped, the laminating layer 1 being molded to a laminated film and melted to couple with the outer surface of the cloth layer 1, such that the laminating layer 4 merges into the clearance between the warp 11 and the woof 12 of the cloth layer 1 so that the laminating layer 4 is integrally formed a rough connecting surface 41, the connecting surface 41 engaging with the clearance of the cloth layer 1, thereby enhancing adhering area, anti-peel strength, and tensile strength. The laminating layer 4 further includes rough patterns 42 formed thereon to obtain anti-slip purpose.

Form above-mentioned description, the laminating layer 4 couples with the cloth layer 1 without through laminating process, and an area of the connecting surface 41 is larger than that of the conventional conveyor belt, because the connecting surface 41 is merged in the clearance between the warp 11 and the woof 12 of the cloth layer 1, a multi-directional stepping stress can be endured so that the laminating layer 4 and the cloth layer 1 are coupled securely to obtain larger stepping stress. Furthermore, because the connecting surface 41 is integrally formed with the laminating layer 4, having a preferred spread effect of stress to improve tensile strength of the cloth layer 1.

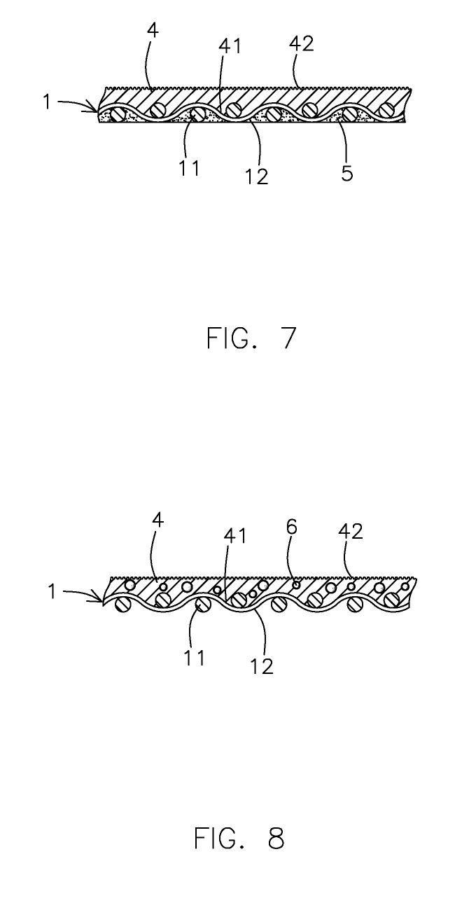

Referring to FIG. 7, a conveyor belt or treadmill belt according to a second embodiment of the present invention at lease comprises:

a cloth layer 1 woven by at least one warp 11 and woof 12, each warp 11 and woof 12 having an outer surface and an inner surface in response to each other, a clearance passing through the inner and the outer surfaces and being formed between the warp 11 and the woof 12;

a laminating layer 4 serving as being stepped, the laminating layer 1 being molded to a laminated film and melted to couple with an outer surface of the cloth layer 1, such that the laminating layer 4 merges into the clearance between the warp 11 and the woof 12 of the cloth layer 1 so that the laminating layer 4 is integrally formed a rough connecting surface 41;

a gel layer 5 coated on an inner surface of the cloth layer 1 so as to link with the connecting surface 41 of the laminating layer 4, thus engaging the cloth layer 1 between the gel layer 5 and the laminating layer 4. The gel layer 5 can improve the anti-wear capacity, and the cloth layer 1, the laminating layer 4, and the gel layer 5 can be joined securely. It is to be noted that the gel layer 5 is added with anti-static agent to prevent from generating static electricity.

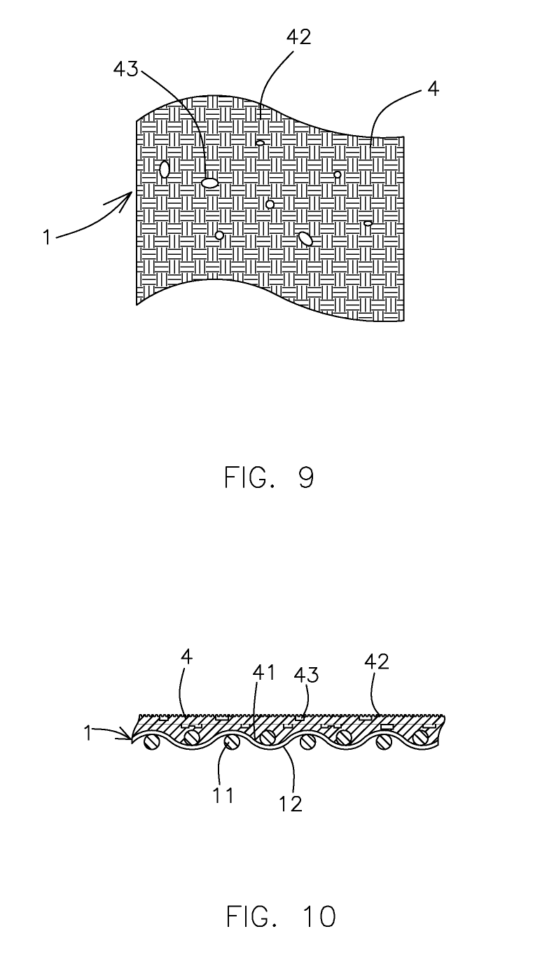

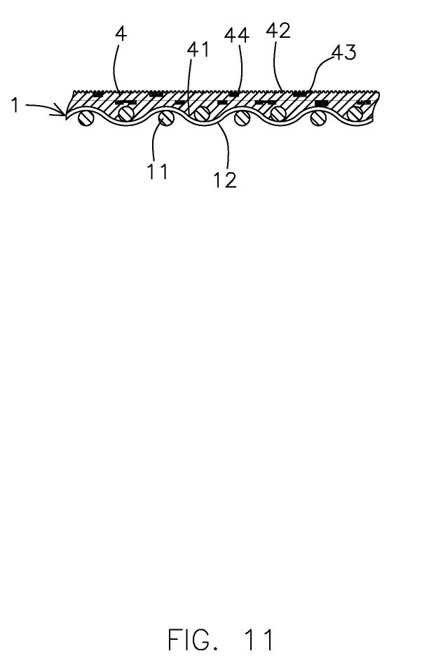

The laminating layer 4 is provided with a shock absorbing structure to obtain stepping comfortness. As shown in FIG. 8, the shock absorbing structure includes a plurality of hollow inflation balls 6 or glass beads disposed on the laminating layer 4. As illustrated in FIGS. 9 and 10, a plurality of air chambers 43 are arranged in the laminating layer 4 to decrease the weight of the laminating layer 4, wherein the chambers 43 are rolled to concavely form on the laminating layer 4, and the chambers 43 can be arranged in a sole, multiple successive, or partially successive manner, the laminating layer 4 can be a double-layer design. As shown in FIG. 11, the chamber 43 is filled with shock absorbing medium, such as gel, fluid, or gas to achieve shock absorbing purpose.

While we have shown and described various embodiments in accordance with the present invention, it is clear to those skilled in the art that further embodiments may be made without departing from the scope of the present invention.

What is claimed is:

1. A conveyor belt or treadmill belt comprising:
a cloth layer woven by at least one warp and woof and having an outer surface and an inner surface in response to each other, a clearance passing through the inner and the outer surfaces and being formed between the warp and the woof of the cloth layer;
a laminating layer serving as being stepped, the laminating layer being molded to a laminated film and melted to couple with an outer surface of the cloth layer, such that the laminating layer merges into the clearance between the warp and the woof of the cloth layer so that the laminating layer is integrally formed a rough connecting surface;
a gel layer coated on the inner surface of the cloth layer so as to link with the connecting surface of the laminating layer, thus engaging the cloth layer between the gel layer and the laminating layer.

2. The conveyor belt or treadmill belt as claimed in claim 1, wherein the gel layer is added with anti-static agent.

3. A conveyor belt or treadmill belt comprising:
a cloth layer woven by at least one warp and woof and having an outer surface and an inner surface in response to each other, a clearance passing through the inner and the outer surfaces and being formed between the warp and the woof of the cloth layer;
a laminating layer serving as being stepped, the laminating layer being molded to a laminated film and melted to couple with an outer surface of the cloth layer, such that the laminating layer merges into the clearance between the warp and the woof of the cloth layer so that the laminating layer is integrally formed a rough connecting surface.

4. The conveyor belt or treadmill belt as claimed in claim 1, wherein the laminating layer further includes rough patterns formed thereon.

5. The conveyor belt or treadmill belt as claimed in claim 3, wherein the laminating layer further includes rough patterns formed thereon.

6. The conveyor belt or treadmill belt as claimed in claim 1, wherein the cloth layer and the laminating layer are added with anti-static agent.

7. The conveyor belt or treadmill belt as claimed in claim 3, wherein the cloth layer and the laminating layer are added with anti-static agent.

8. The conveyor belt or treadmill belt as claimed in claim 1, wherein the laminating layer is provided with a shock absorbing structure.

9. The conveyor belt or treadmill belt as claimed in claim 3, wherein the laminating layer is provided with a shock absorbing structure.

10. The conveyor belt or treadmill belt as claimed in claim 8, wherein the shock absorbing structure includes a plurality of hollow inflation balls disposed on the laminating layer.

11. The conveyor belt or treadmill belt as claimed in claim 9, wherein the shock absorbing structure includes a plurality of hollow inflation balls disposed on the laminating layer.

12. The conveyor belt or treadmill belt as claimed in claim 8, wherein the shock absorbing structure includes a plurality of hollow glass beads disposed on the laminating layer.

13. The conveyor belt or treadmill belt as claimed in claim 9, wherein the shock absorbing structure includes a plurality of hollow glass beads disposed on the laminating layer.

14. The conveyor belt or treadmill belt as claimed in claim 8, wherein a plurality of air chambers are arranged in the laminating layer, the chambers are rolled to concavely form on the laminating layer, and the chambers can be arranged in a sole manner, and the chamber is filled with shock absorbing medium.

15. The conveyor belt or treadmill belt as claimed in claim 8, wherein a plurality of air chambers are arranged in the laminating layer, the chambers are rolled to concavely form on the laminating layer, and the chambers can be arranged in a multiple successive manner, and the chamber is filled with shock absorbing medium.

16. The conveyor belt or treadmill belt as claimed in claim 8, wherein a plurality of air chambers are arranged in the laminating layer, the chambers are rolled to concavely form on the laminating layer, and the chambers can be arranged in a partially successive manner, and the chamber is filled with shock absorbing medium.

17. The conveyor belt or treadmill belt as claimed in claim 9, wherein a plurality of air chambers are arranged in the laminating layer, the chambers are rolled to concavely form on the laminating layer, and the chambers can be arranged in a sole manner, and the chamber is filled with shock absorbing medium.

18. The conveyor belt or treadmill belt as claimed in claim 9, wherein a plurality of air chambers are arranged in the laminating layer, the chambers are rolled to concavely form on the laminating layer, and the chambers can be arranged in a multiple successive manner, and the chamber is filled with shock absorbing medium.

19. The conveyor belt or treadmill belt as claimed in claim 9, wherein a plurality of air chambers are arranged in the laminating layer, the chambers are rolled to concavely form on the laminating layer, and the chambers can be arranged in a partially successive manner, and the chamber is filled with shock absorbing medium.
